(19) United States
(12) Patent Application Publication
(10) Pub. No.: US 2017/0260865 A1
(43) Pub. Date: Sep. 14, 2017

(54) PROCESS FOR PRODUCING A BLADE FOR A TURBOMACHINE

(71) Applicant: MTU Aero Engines AG, Munich (DE)

(72) Inventor: Martin SCHLOFFER, Munich (DE)

(21) Appl. No.: 15/451,529

(22) Filed: Mar. 7, 2017

(30) Foreign Application Priority Data
Mar. 8, 2016 (DE) 102016203785.4

(51) Int. Cl. F01D 5/28; C22F 1/18; B22F 3/105; B22F 3/15; B22F 3/24; B22F 5/04; B23K 15/00; B23K 15/06; B23K 26/342; B23K 26/00; B23K 26/12; B23K 26/70; C22C 30/00; B33Y 10/00; B33Y 70/00; B33Y 80/00; B28B 1/00; C22C 14/00

(52) U.S. Cl. CPC F01D 5/28; C22C 14/00; C22F 1/183; B22F 3/1055; B22F 3/15; B22F 3/24; B22F 5/04; B23K 15/0006; B23K 15/0086; B23K 15/0093; B23K 15/06; B23K 26/342; B23K 26/0006; B23K 26/1224; B23K 26/70; C22C 30/00; B33Y 10/00; B33Y 70/00; B33Y 80/00; B28B 1/001; F05D 2220/323; F05D 2230/22; F05D 2230/41; F05D 2230/42; F05D 2300/174; F05D 2300/20; B22F 2003/248; B22F 2301/205; B22F 2998/10; B23K 2201/001

(57) ABSTRACT

The invention relates to a method for producing a blade (10) for a turbo machine, especially for an aviation engine, comprising at least the following steps:
provision of a monocrystalline or polycrystalline basic body (14) with a supporting surface (16), and generative construction of a blade airfoil (12) of the blade (10) on the supporting surface (16) by layer-by-layer melting and/or sintering of a metallic and/or ceramic powder consisting of a first material (18) or material mixture; and
separation of the blade airfoil (12) from the supporting surface (16) of the basic body (14) on a parting surface (20) of the blade airfoil (12).

A further aspect of the invention relates to a blade which is obtainable and/or is obtained by means of such a method.

The invention relates to a method for producing a blade for a turbomachine, especially for an aviation engine. A further aspect of the invention relates to such a blade which is obtainable and/or is obtained by means of a corresponding method.

In the production of blades for turbomachines, the greatest care is necessary for ensuring a high failsafe requirement. In the design and production of blades, a considerable challenge lies in the fact that on the one hand these are expected to withstand extreme mechanical and thermal stresses and on the other hand a highest possible level of efficiency during operation of the turbomachine is expected to be achieved.

A method for the complete construction of a component from a metallic powder is known from US 2011/0135952 A1. The construction is carried out on a seed crystal so that an orientation of the seed crystal can be impressed upon a structure of the component during production.

Printed document DE 10 2012 222 745 A1 describes a casting process in which a monocrystalline and one-piece turbine blade is produced. The turbine blade is formed in this case from a TiAl material, wherein after the casting process different material structures exist in various regions of the turbine blade.

US 2014/0154088 A1 features a layered construction of a turbine blade on a metallic base material. As a result, a texture of the metallic base material is impressed upon the turbine blade by means of a generative production process. The base material which is associated with the turbine blade is used as a one-piece component of a gas turbine.

It is the object of the present invention to create a method of the type referred to in the introduction, which allows a particularly low-cost production of blades. It is a further object of the invention to provide a blade in which at least individual components of the blade are producible in a particularly simple manner.

The objects are achieved according to the invention by means of a method having the features of patent claim 1 and by means of a blade according to patent claim 12. Advantageous embodiments with expedient developments of the invention are disclosed in the respective dependent claims, wherein advantageous embodiments of each inventive aspect are to be seen as advantageous embodiments of the respectively other inventive aspect and vice versa.

A first aspect of the invention relates to a method for producing a blade for a turbomachine, especially for an aviation engine, comprising at least the following steps:
provision of a monocrystalline or polycrystalline basic body with a supporting surface, and generative construction of a blade airfoil of the blade on the supporting surface by means of layer-by-layer melting and/or sintering of a metallic and/or ceramic powder of a first material or material mixture; and
separation of the blade airfoil from the supporting surface of the basic body on a parting surface of the blade airfoil.

The generative construction by means of layer-by-layer melting can be carried out in this case especially by directional solidification.

The metallic and/or ceramic powder, which is sintered, can especially also comprise an intermetallic powder or can consist of such.

The powder can especially be sintered, forming a polycrystal or single crystal, preferably an oriented polycrystal or single crystal.

The basic body can be provided as a TiAl starting seed plate, and therefore for example as a beta TiAl-crystal plate of monocrystalline or polycrystalline design. This plate can be directionally solidified and therefore have a defined crystal orientation. En the case of the generative construction, for example electron beam melting, which can also be referred to as an EBM process, and additionally or alternatively selective laser melting, which can also be referred to as an SLM process, can be used. In the case of the generative construction, for example a powder bed can be provided from a powder of the first material or material mixture and the blade airfoil can be constructed directly by melting or sintering of the powder on the supporting surface of the basic body. In the process, a directional solidification of a liquid melt, which is formed from the powder during the generative construction, is carried out. During the solidification of the melt, for example an orientation of the beta phase of the basic body is impressed upon a material structure of the blade airfoil during its production in this case. Such a beta-phase is also consequently created in the blade airfoil. By the impressing of the orientation of the beta-phase of the basic body, a columnar crystalline construction of a beta grain structure can be produced as the material structure of the blade airfoil. The material structure can be oriented in this case along a longitudinal axis of the blade airfoil. Therefore, individual columnar crystals can be oriented in the blade airfoil parallel to the longitudinal axis after the solidification. The corresponding orientation is controlled in this case during the generative construction. After the blade airfoil has been finished in its construction, this is separated from the basic body. The blade airfoil can then be connected to a blade root, forming the blade. After separation from the blade airfoil, the basic body together with the corresponding supporting surface can be used for producing further blade airfoils, as a result of which a particularly low-cost blade production is possible overall. All suitable additive production and construction processes are understood by “generative construction” or “generative process” according to the present invention.

In an advantageous embodiment of the invention, the separating of the blade airfoil from the supporting surface of the basic body is carried out by eroding. As a result, a particularly careful separating of the basic body from the blade airfoil is possible. The same basic body can consequently be particularly frequently used for producing further blade airfoils.

In a further advantageous embodiment of the invention, a generative construction of a blade root of the blade on the parting surface of the blade airfoil is carried out and in the process a connecting of the blade root to the blade airfoil. The generative construction of the blade root on the parting surface can also be carried out by means of EBM and additionally or alternatively by means of SLM. For example, the blade airfoil, after separation from the basic body, can be inverted and consequently with the parting surface oriented upward can be positioned in an EBM/SLM powder bed of the first material or a second material or material mixture. The second material or the second material mixture can be formed from a γ-TiAl alloy which is more ductile in comparison to the first material or material mixture. After the positioning of the blade airfoil, the powder bed (for example consisting of the γ-TiAl alloy) can also be heated and following that the blade root can be constructed with a desired structure. Therefore, different structures can be created in the blade airfoil and in the blade root in a simple manner.

In a further advantageous embodiment of the invention, the blade root, during the generative construction, is produced by means of layer-by-layer melting and/or sintering of a metallic and/or ceramic powder of the second material or material mixture which is different from the first material or material mixture. As a result, different material properties are established in the blade root and in the blade airfoil in a particularly simple manner.

In a further advantageous embodiment of the invention, the generative construction of the blade root is created in such a way that a polycrystalline structure is produced in this. Owing to the production of a polycrystalline structure the blade root has a particularly high level of ductility.

In a further advantageous embodiment of the invention, the generative construction of the blade airfoil and/or of the blade root is carried out in a construction chamber which is exposed to a negative pressure. By exposing the construction chamber to negative pressure a particularly effective compression of the powder can be carried out during the construction of the blade airfoil and therefore the latter can be produced with a particularly low proportion of voids and correspondingly high stability. Furthermore, a low air proportion as a result of the negative pressure environment contributes to any undesirable oxidation processes of the powder during its layered melting and/or sintering as a result of the generative construction being less strongly pronounced than would be the case under atmospheric air pressure and correspondingly larger air proportions in the powder.

In a further advantageous embodiment of the invention, the blade root and the blade airfoil, after connecting, are subjected to a common high-temperature isostatic pressing. in the case of this high-temperature isostatic pressing, which can also be abbreviated as “HIP”, a microstructure in the blade root, produced for example from TNM-TiAl, is converted into a so-called triplex microstructure with a high globular gamma proportion, as a result of which for example a good cutability of the blade root can be achieved. Following the HIP, a finished machining of the blade, for example in the form of a finished contour machining, can be carried out.

In a further advantageous embodiment of the invention, the blade root and the blade airfoil, after connecting, are subjected to a common age-annealing. As a result of the age-annealing, mesh-like omega precipitations can be created in the directionally solidified beta phase of the blade airfoil. As a result, the blade airfoil can be formed in a particularly stable manner. As a result of this heat treatment (age-annealing), directed, mesh-like microstructures are established in the blade airfoil by means of which especially high requirements for a creep resistance of the blade can be fulfilled.

In a further advantageous embodiment of the invention, a TiAl alloy, especially a TiAl alloy which in addition to Ti and Al comprises as a further alloy constituent at least one element from the group including Nb, Mo, W, Zr, V, Y, Hf, Si, C and Co, is provided as the first material. As a result of these alloy constituents, a particularly specific establishing of component properties can be achieved. Therefore, these alloys are especially suitable in order to establish the component properties for example of the blade airfoil.

In a further advantageous embodiment of the invention, the TiAl alloy comprises 30 to 42 at. % Al, 5 to 25 at. % Nb, 2 to 10 at. % Mo, 0.1 to 10 at. % Co, 0.1 to 0.5 at. % Si, 0.1 to 0.5 at. % Hf and remainder Ti, especially 30 to 35 at. % Al, 15 to 25 at. % Nb, 5 to 10 at. % Mo, 5 to 10 at. % Co, 0.1 to 0.5 at. % Si, 0.1 to 0.5 at. % Hf and remainder Ti. A TiAl alloy with such a composition is particularly suitable for use as blade material.

In a further advantageous embodiment of the invention, the TiAl alloy comprises 30 to 42 at. % Al, 5 to 25 at. % Nb, 2 to 10 at. % Mo, 0.1 to 10 at. % Zr, 0.1 to 1.5 at. % Si, 0.1 to 0.5 at. % Hf and remainder Ti, especially 32 to 37 at. % Al, 15 to 25 at. % Nb, 5 to 10 at. % Mo, 1 to 10 at. % Zr, 0.2 to 1.0 at. % Si, 0.1 to 0.5 at. % Hf and remainder Ti. A TiAl alloy with such a composition is also particularly suitable for use as blade material.

Use can especially be made of TiAl alloys according to the compositions described in printed document EP 2 905 350 A1 from which for example particularly stable blade airfoils can be formed.

In a further advantageous embodiment of the invention, a TiAl alloy, especially a γ-TiAl alloy, is provided as the second material. Such a γ-TiAl alloy, which can also be referred to as TNM-TiAl, has a particularly high thermal resistance with a simultaneously low density. Therefore, γ-TiAl is especially suitable for use in aviation engines, therefore as material for the blade root for example.

A second aspect of the invention relates to a blade for a turbomachine, especially for an aviation engine, which is obtainable and/or is obtained by means of such a method according to the invention. Such a blade can be produced in a particularly simple manner. Further features and their advantages are to be gathered from the descriptions of the first inventive aspect, wherein advantageous embodiments of the first inventive aspect are to be seen as advantageous embodiments of the second inventive aspect and vice versa.

Further features of the invention are obtained from the claims, the exemplary embodiments and also from the drawing. The features and feature combinations previously referred to in the description, and also the features and feature combinations which are referred to below in the exemplary embodiments and/or described alone are applicable not only in the respectively disclosed combination but also in other combinations or alone without departing from the scope of the invention. There are therefore also embodiments of the invention to be seen as being covered and disclosed which are not explicitly featured and explained in the exemplary embodiments but which originate from and are producible from the explained embodiments by means of separate feature combinations. There are also embodiments and feature combinations to be seen as being disclosed which therefore do not have all the features of an originally formulated independent claim. In this case, in the drawing:

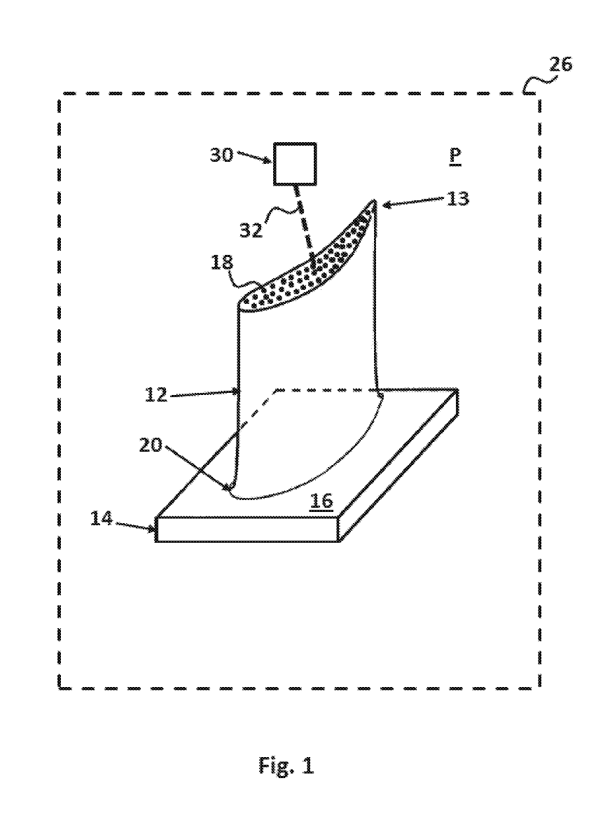

FIG. 1 shows a schematic perspective view of a blade airfoil of a blade according to the invention, wherein the blade airfoil is generatively constructed on a basic body;

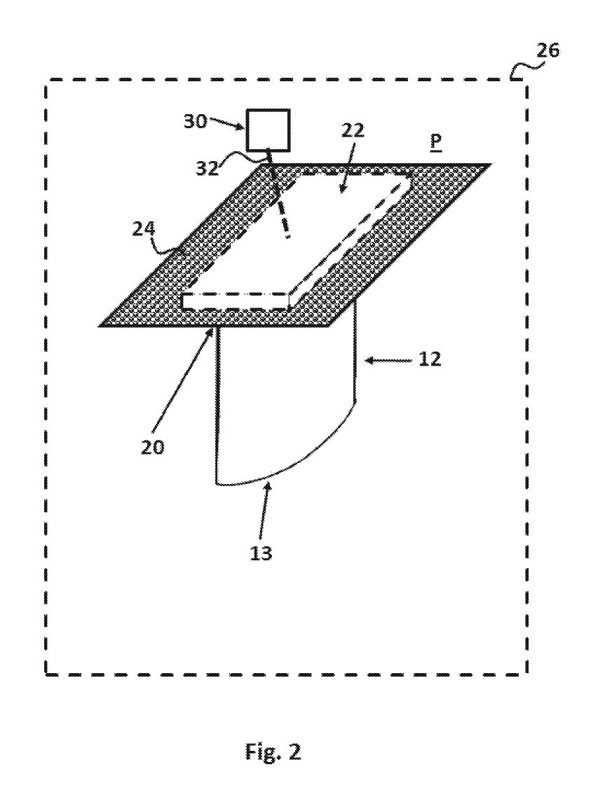

FIG. 2 shows a schematic perspective view of a blade root of the blade according to the invention, wherein the blade root is generatively constructed on a parting surface of the blade airfoil; and

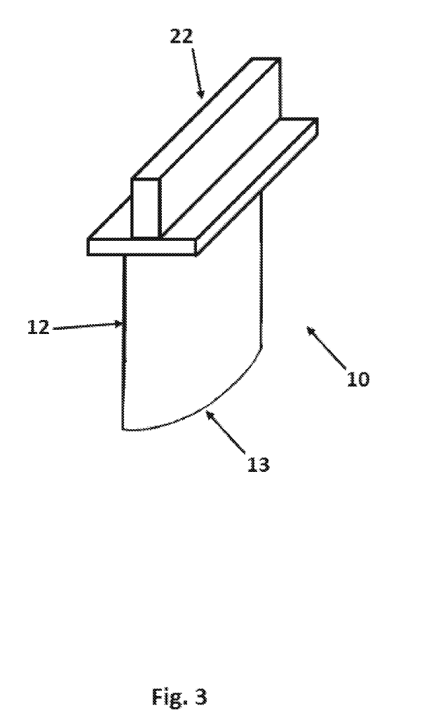

FIG. 3 shows a schematic perspective view of the blade according to the invention.

FIG. 1 and FIG. 2 show individual method steps of a method according to the invention for producing a blade 10 for a turbomachine. The blade 10 is shown in full in FIG. 3 in this case.

FIG. 1 shows a generative construction of a blade airfoil 12 of the blade 10 on a presently polycrystalline basic body 14, Alternatively or additionally, the basic body 14 can also be monocrystalline and/or directionally solidified. The generative construction is carried out in this case by means of electron beam melting or selective laser sintering, wherein a first material 18, in the present case as a metallic powder, is sintered by means of an electron beam or laser beam 32. The electron beam/laser beam 32 is emitted by means of an electron beam gun or a laser 30. The blade airfoil 12 is constructed in this case on a supporting surface 16 of the basic body 14. The basic body 14 in the present case is designed as a beta TiAl crystal plate. As a result of the generative construction of the blade airfoil 12 on the monocrystalline or polycrystalline, preferably directionally solidified, basic body 14, an orientation of a beta phase of the basic body 14 can be impressed upon a material structure of the blade airfoil 12 during its production.

Following the construction of the blade airfoil 12, a separation, not shown here, of the blade airfoil 12 from the supporting surface 16 of the basic body 14 is carried out on a parting surface 20 of the blade airfoil 12. The separation of the blade airfoil 12 from the supporting surface 16 of the basic body 14 is preferably carried out in this case by means of erosion. This constitutes a particularly careful separation process, as a result of which the basic body 14 can be used for the construction of further blade airfoils.

FIG. 2 shows a further method step in which a generative construction of a blade root 22 of the blade 10 on the parting surface 20 of the blade airfoil 12, and in the process connecting of the blade root 22 to the blade airfoil 12, is carried out. For this purpose, the blade airfoil 12 is located in an inverted position in comparison to FIG. 1 so that a blade tip 13 is now directed downward in FIG. 2 in the plane of the drawing. Consequently, the parting surface 20 is directed upward. The parting surface 20 is covered with a metallic powder of a second material 24. The blade root 22 is constructed by means of layered sintering of the powder of the second material 24 using the electron beam/laser beam 32. The two materials 18, 24 are different from each other in this case.

The first material 18 is designed in the present case as a TiAl alloy which in addition to Ti and Al comprises molybdenum as a further alloy constituent. Alternatively, in addition to Ti and Al, niobium and molybdenum can also be included as further alloy constituents. The TiAl alloy can also comprise other elements, or a plurality of elements, from the group comprising Mo, W, Zr, V, Y, Hf, Si, C and Co in order to establish eventual material properties of the blade airfoil 22 as accurately as possible. In the present case, a γ-TiAl alloy is provided as the second material 24.

in many embodiments, the γ-TiAl alloy can be provided with the composition TNM Ti41 -44Al2-5Nb0.5-2Mo 0.01-0.5B, optionally +0.2-0.5Si 0.2-0.5C [at. %]. This specification of the composition is the customary nomenclature in the field of expertise, in which Ti is the balance and makes up the remainder of 100 at. % or—apart from unavoidable impurities—makes up the remainder of 100 at. %. The blade root 22 and the blade airfoil 12, after connecting, are subjected to a common high-temperature isostatic pressing—not additionally shown here—and also to a common age-annealing which follows this.

The described method is carried out in the present case entirely in a construction chamber 26 which is shown by dashed lines in FIG. 1 and FIG. 2, wherein the construction chamber 26 is exposed to a negative pressure P while the method is being conducted. Consequently, in addition to the generative production of the blade airfoil 12 on the basic body 14 the separation of the basic body 14 from the blade airfoil 12 and also the generative construction of the blade root 22 on the blade airfoil 12 in the construction chamber 26, which is exposed to the negative pressure P, is also carried out. This has the advantage that any oxidation processes during the overall production of the blade can be at least largely excluded. As a result of the negative pressure P, any oxidation processes during the method can be at least weakened.

FIG. 3 shows the blade 10 after its production. The blade 10 can now be joined by the blade root 22 for example to a rotor basic body, which is not additionally shown here. In the case of the joining, for example a plug-in connection between the blade root 22 and the rotor basic body can be produced.

The method is based on the knowledge that via a beta phase beta TiAl alloys solidifying from their melting temperature to room temperature have an even crystal orientation. As a result, the basic body 14 can be provided by this being produced by means of a drawing and separation process in a suitable furnace (for example in a Bridgman furnace). During this, a directional solidification of the crystals can be achieved on account of a controlled temperature gradient and crystal separator. Consequently, a directionally solidified monocrystalline or polycrystalline beta TiAl crystal or crystallite block can be grown as the basic body 14.

### LIST OF REFERENCE NUMERALS

10 Blade
12 Blade airfoil
13 Blade tip
14 Basic body
16 Supporting surface
18 First material
20 Parting surface
22 Blade root
24 Second material
26 Construction chamber
30 Electron beam gun/laser
32 Electron beam or laser beam

1.-12. (canceled)

13. A method for producing a blade for a turbomachine, wherein the method comprises:
providing a monocrystalline or polycrystalline basic body having a supporting surface, and generatively constructing a blade airfoil of the blade on the supporting surface by layer-by-layer melting and/or sintering of a metallic and/or ceramic powder of a first material or material mixture; and
separating the blade airfoil from the supporting surface of the basic body on a parting surface of the blade airfoil.

14. The method of claim 13, wherein separating of the blade airfoil from the supporting surface of the basic body is carried out by erosion.

15. The method of claim 13, wherein the method further comprises generatively constructing a blade root of the blade on the parting surface of the blade airfoil and thereby connecting the blade root to the blade airfoil.

16. The method of claim 15, wherein the blade root, during generative construction thereof, is produced by layer-by-layer melting and/or sintering of a metallic and/or ceramic powder of a second material or material mixture which is different from the first material or material mixture.

17. The method of claim 15, wherein generative construction of the blade root is carried out in such a way that a polycrystalline structure is produced in the blade root.

18. The method of claim 15, wherein generative construction of the blade airfoil and/or of the blade root is carried out in a construction chamber which is exposed to a negative pressure.

19. The method of claim 15, wherein after connecting, the blade root and the blade airfoil are subjected to a common hot isostatic pressing.

20. The method of claim 15, wherein after connecting, the blade root and the blade airfoil are subjected to a common age-annealing.

21. The method of claim 13, wherein the first material or material mixture comprises a TiAl alloy.

22. The method of claim 21, wherein the TiAl alloy comprises, in addition to Ti and Al, one or more of Nb, Mo, W, Zr, V, Y, Hf, Si, C, Co.

23. The method of claim 21, wherein the TiAl alloy comprises
from 30 to 42 at. % Al
from 5 to 25 at. % Nb
from 2 to 10 at. % Mo
from 0.1 to 10 at. % Co or Zr
from 0.1 to 1,5 at. % Si,
from 0.1 to 0.5 at. % Hf,
remainder Ti.

24. The method of claim 23, wherein the TiAl alloy comprises from 0.1 to 0.5 at. % Si.

25. The method of claim 21, wherein the TiAl alloy comprises
from 30 to 35 at. % Al
from 15 to 25 at. % Nb
from 5 to 10 at. % Mo
from 1 to 10 at. % Co or Zr,
from 0.1 to 0.5 at. % Si
from 0.1 to 0.5 at. % Hf,
remainder Ti.

26. The method of claim 25, wherein the TiAl alloy comprises from 32 to 37 at. % Al.

27. The method of claim 25, wherein the TiAl alloy comprises from 5 to 10 at. % Co or Zr.

28. The method of claim 25, wherein the TiAl alloy comprises from 0.2 to 1.0 at. % Si.

29. The method of claim 26, wherein the TiAl alloy comprises from 5 to 10 at. % Co or Zr and from 0.2 to 1.0 at. % Si.

30. The method of claim 15, wherein the blade root comprises a second material or material mixture which comprises a TiAl alloy.

31. The method of claim 30, wherein the TiAl alloy is a γ-TiAl alloy.

32. A blade for a turbomachine, wherein the blade has been produced by the method of claim 13.
